(19) United States
(12) Patent Application Publication
(10) Pub. No.: US 2026/0295647 A1
(43) Pub. Date: Oct. 1, 2026

(54) MULTIPLE-BILLET HOT ROLLING PLANT WITH JOINT COOLING SYSTEM

(71) Applicant: POMINI LONG ROLLING MILLS S.R.I., Legnano (MI) (IT)

(72) Inventors: Virginio POMETTO, Bovisio Masciago (MB) (IT); Lorenzo FERRO, Legnano (MI) (IT)

(21) Appl. No.: 19/480,926

(22) PCT Filed: Apr. 30, 2024
(86) PCT No.: PCT/IB2024/054170

§ 371 Date: Nov. 3, 2025

(30) Foreign Application Priority Data
May 4, 2023 (IT) 102023000008892

(51) Int. Cl. B21B 15/00; B21B 45/02; B23K 31/02; B23K 37/003; B23K 101/28

(52) U.S. Cl. CPC B21B 15/0085; B21B 45/0224; B21B 45/0233; B23K 31/02; B23K 37/003; B23K 2101/28

(57) ABSTRACT

A multiple-billet hot rolling plant with a joint cooling system comprising a heated billet production assembly (10) adapted to unload a plurality of billets (2a, 2b) along a predetermined longitudinal feed direction (X), a rolling mill (20) comprising a plurality of stands (22, 22′, 22″, 22′″) and arranged downstream of the heated billet production assembly (10) along said feed direction (X), and a welding machine (30) arranged between the heated billet production assembly (10) and a first stand (22) of the rolling mill (20) along said feed direction (X). The plant (1) further comprises a joint cooling system (40) arranged downstream of the welding machine (30) along said feed direction (X).

The present invention relates to the field of rolling plants, and in particular to rolling plants for multiple billets in output from a reheating furnace or directly from continuous casting. The invention was developed with particular reference to, though not limitedly, a multiple-billet hot rolling plant with joint cooling system.

In plants comprising a reheating furnace or continuous casting and a subsequent rolling mill, billets can be rolled with a continuous or discontinuous method. In the second case, the billets in output from the reheating furnace or continuous casting are individually fed and processed by the rolling mill with a sufficient time interval so as not to limit production efficiency.

In contrast, the continuous methods involve rolling a continuous billet obtained by means of spark welding of billets discontinuously output from the reheating furnace or directly from continuous casting. In particular, the tail of a billet already introduced into the rolling mill is welded with the head of a billet in output from the reheating furnace or from continuous casting by means of a welder arranged between the reheating furnace and the first rolling mill stand. Such an operation allows to obtain a rolling without interruptions, viz., continuous. Continuous rolling plants of this type are described in EP0761330, EP0832700 and EP1065012.

Numerous experiments conducted by the Applicant have shown that the finished products resulting from a continuous rolling process such as that described above, e.g., a rolled rod, have non-uniform mechanical characteristics, having portions of material with mechanical characteristics, e.g., mechanical strength, which are not mutually homogeneous.

The general aim of the present invention is to further reduce the variation in the mechanical strength values of rolled products, and therefore, further increase the quality level of the finished product.

In view of such an aim, the Applicant has thought to make, according to the invention, a multiple-billet hot rolling plant with a joint cooling system comprising:
a heated billet production assembly configured to unload a plurality of heated billets along a predetermined longitudinal feed direction,
a rolling mill comprising a plurality of stands and arranged downstream of the heated billet production assembly along said feed direction,
a welding machine arranged between the heated billet production assembly and a first rolling mill stand along said feed direction,
a joint cooling system arranged downstream of the welding machine and upstream of the first rolling mill stand along said feed direction,
   characterised in that the joint cooling system comprises a cooling device arranged downstream of the welding machine, said cooling device being movable along the predetermined longitudinal feed direction to and from the welding machine and to and from the first stand.

Further features and advantages of the present invention will become apparent from the following description, given by way of example, with reference to the accompanying drawings, wherein:

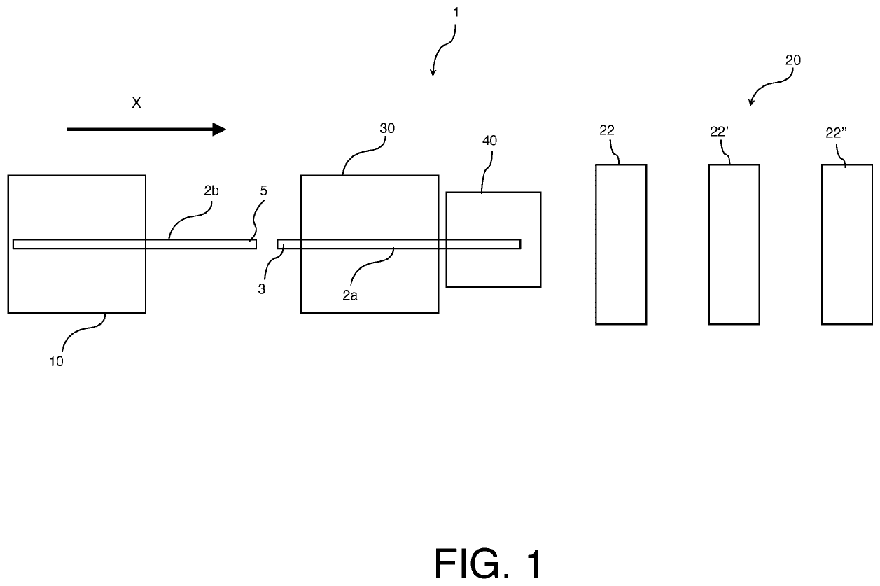

FIG. 1 is a schematic representation of a first embodiment of the rolling plant according to the present invention;

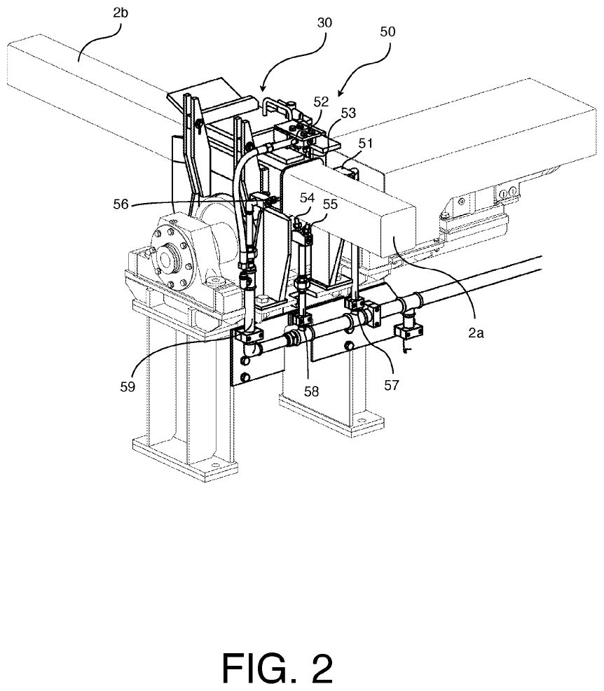

FIG. 2 is a schematic axonometric view of a first embodiment of a cooling device according to the present invention;

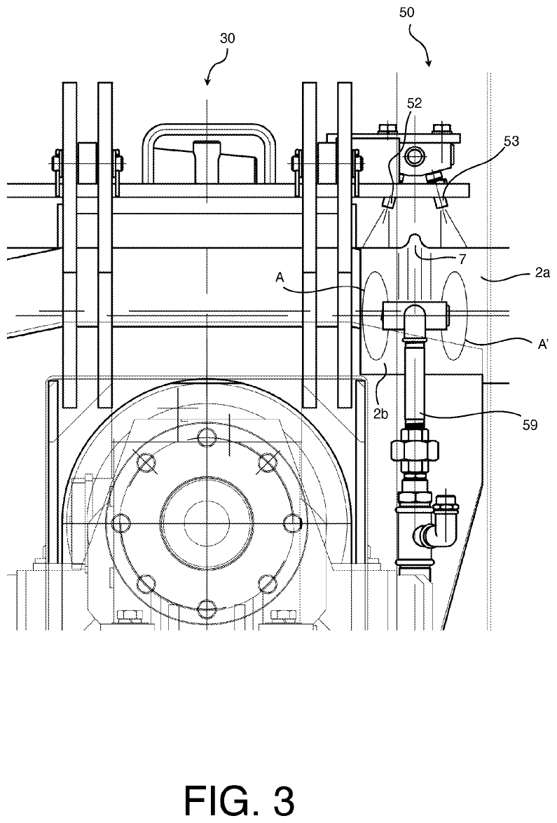

FIG. 3 is a partial sectional view of the device of FIG. 2;

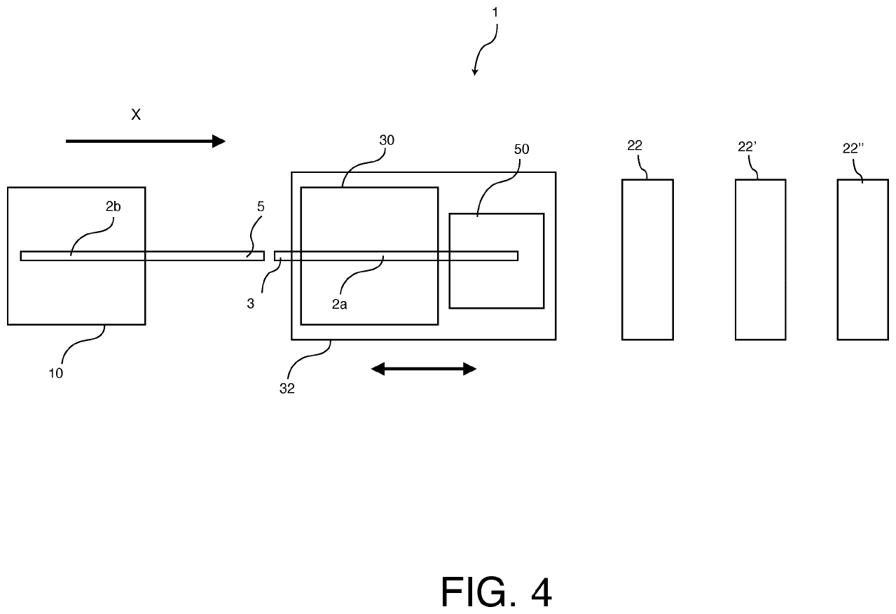

FIG. 4 is a schematic representation of a second embodiment of the rolling plant according to the present invention;

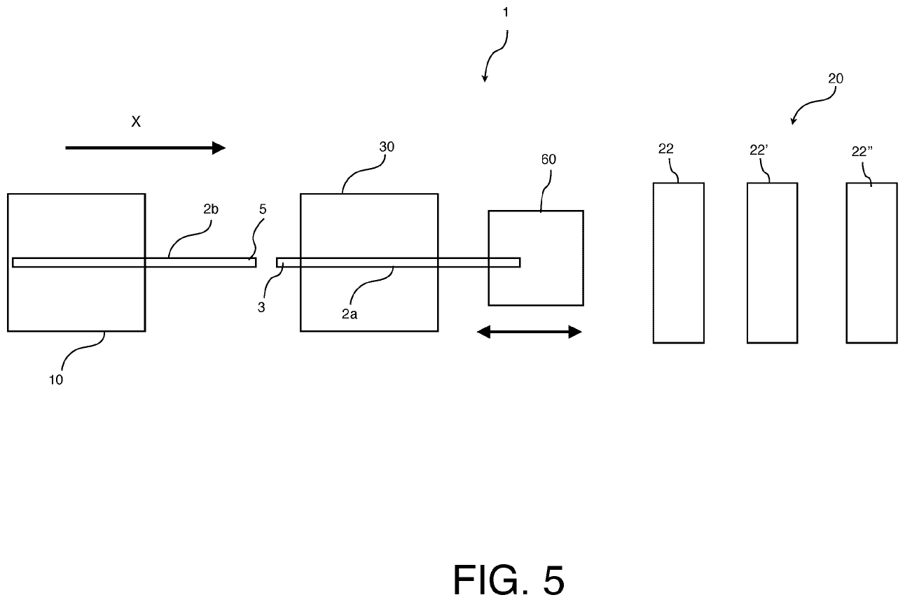

FIG. 5 is a schematic representation of a third embodiment of the rolling plant according to the present invention;

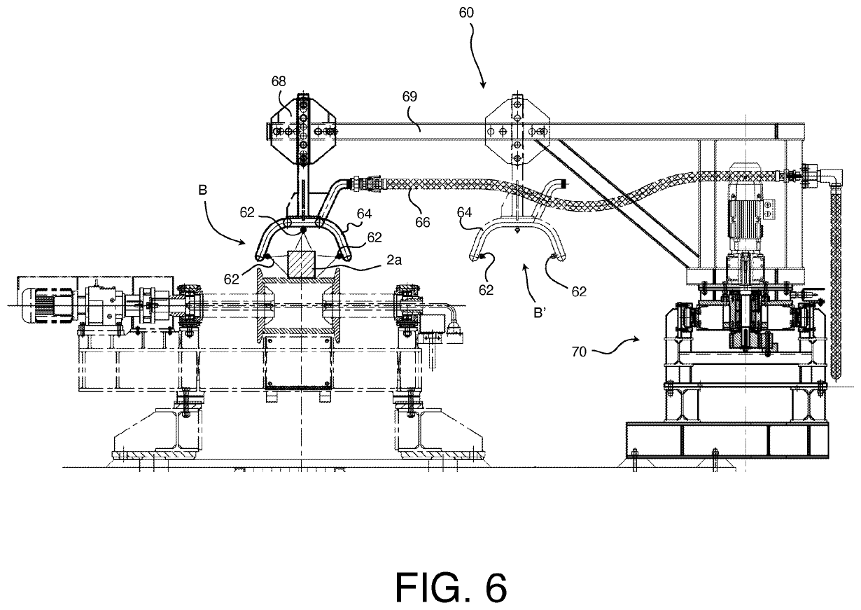

FIG. 6 is a schematic axonometric view of a second embodiment of a cooling device according to the present invention;

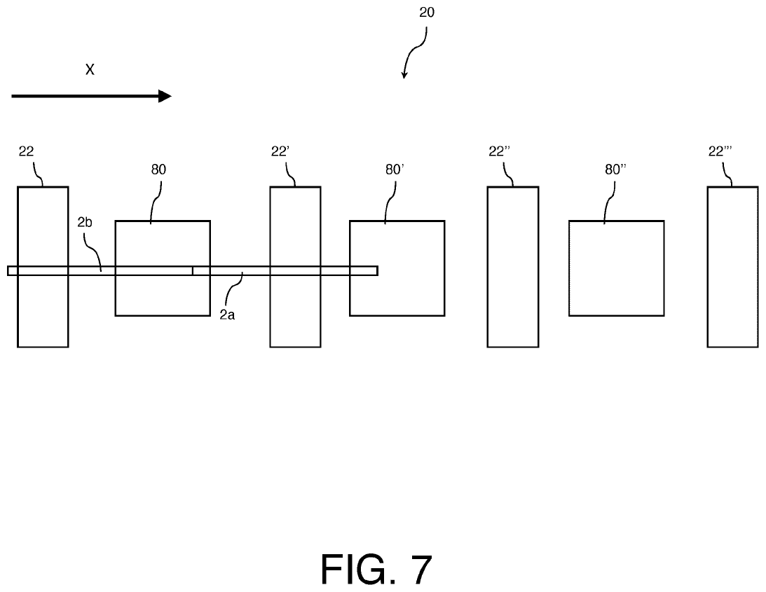

FIG. 7 is a schematic representation of a further embodiment of the rolling plant according to the present invention;

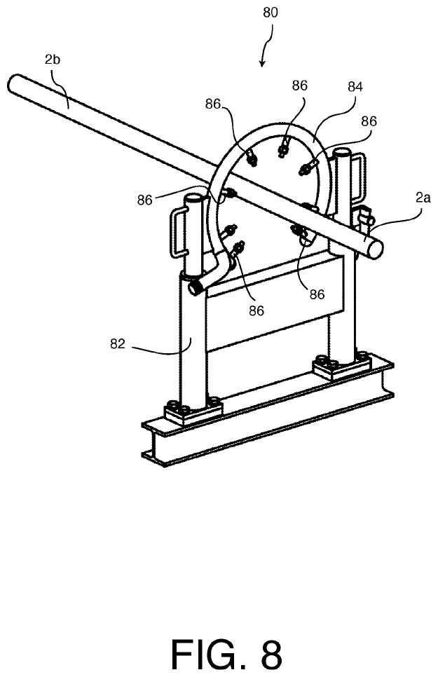

FIG. 8 is a schematic axonometric view of a third embodiment of a cooling device according to the present invention;

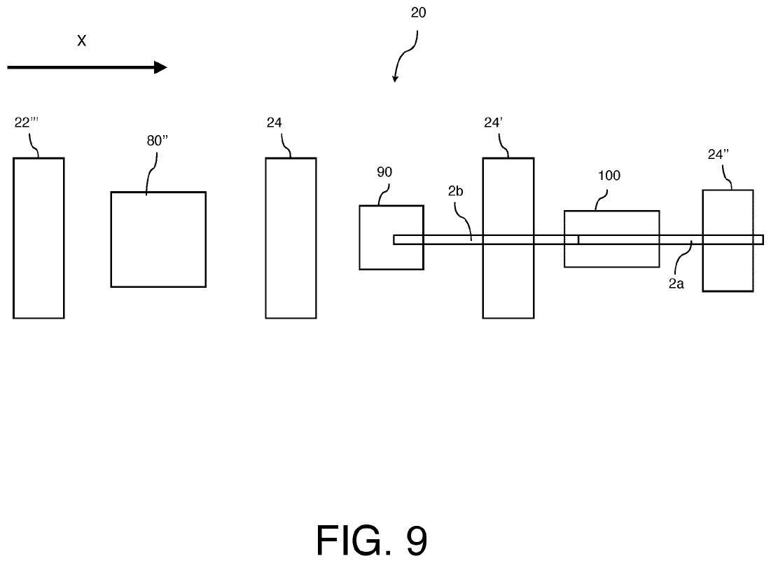

FIG. 9 is a schematic representation of another embodiment of the rolling plant according to the present invention;

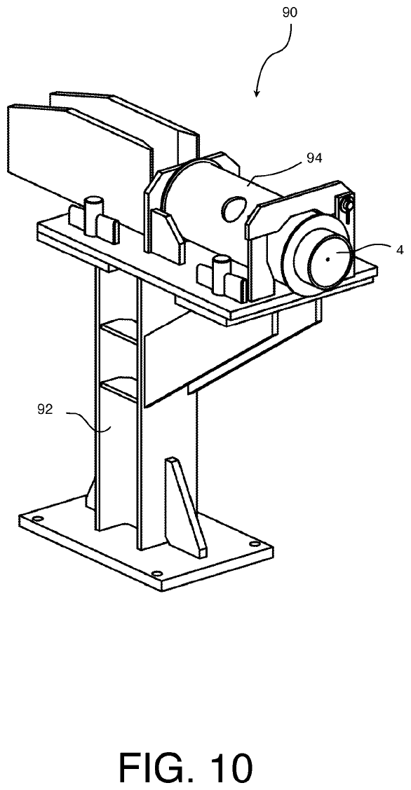

FIG. 10 is a schematic axonometric view of a fourth embodiment of a cooling device according to the present invention; and

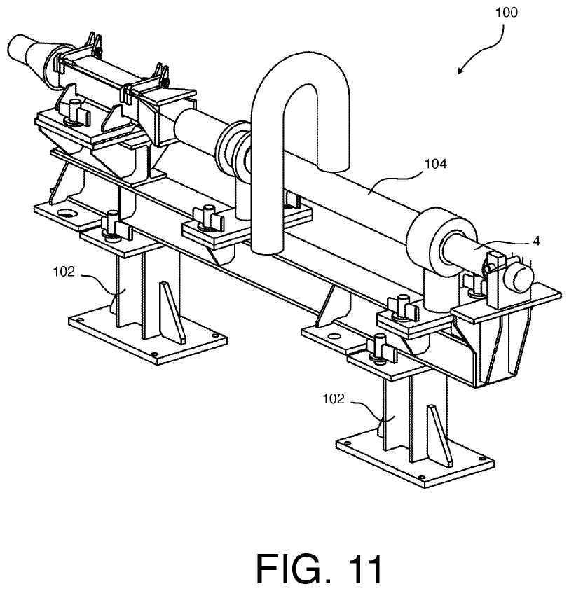

FIG. 11 is a schematic axonometric view of a fifth embodiment of a cooling device according to the present.

It is to be understood that elements and features of one embodiment may conveniently be incorporated into other embodiments without further clarifications.

Reference is now made in detail to various embodiments of the invention, one or more of which are illustrated in the accompanying drawings. Each example is provided merely to illustrate the invention and is not intended as a limitation thereof. For example, the technical features illustrated or described because they belong to one embodiment may be implemented in, or in association with, other embodiments in order to generate a further embodiment. It is understood that the present invention is comprehensive of such modifications and variants.

In a first embodiment of the present invention, a multiple-billet hot rolling plant with a joint cooling system, generically referred to as 1, comprises a heated billet production assembly 10, configured to unload, in use, a plurality of heated billets 2a, 2b. The heated billets 2a, 2b are unloaded and moved according to a pre-determined longitudinal feed direction X corresponding to an unloading direction. The heated billet production assembly 10 can comprise, for example, a billet heating furnace or a continuous casting.

The rolling plant 1 comprises a rolling mill 20, consisting of a succession of stands 22, 22′, 22″, 22′″ arranged along the aforesaid predetermined feed direction X corresponding to a rolling direction. Each stand 22, 22′, 22″, 22′″ is arranged spaced from an adjoining stand and comprises technical features known to a person skilled in the art, which will therefore not be further described for the sake of brevity.

The rolling plant 1 also comprises a welding machine 30 arranged downstream of the reheating furnace or continuous casting 10 and upstream of the first stand 22 of the rolling mill 20 along said predetermined feed direction X. The welding machine 30 is configured to weld, in use, an end 3, tail, of a first billet 2a already output by the heated billet production assembly 10 with an end 5, head, of a second billet 2b in output from the heated billet production assembly 10. Also in this case, the welding machine 30 comprises technical features known to a person skilled in the art, which will therefore not be further described for the sake of brevity.

The plant 1 comprises movement means adapted to support and transport the heated billets 2a, 2b along said feed direction. For example, but not limitedly, the movement means can comprise a plurality of rollers 15 arranged upstream and downstream of the welding machine 30.

According to a particularly advantageous feature of the present invention, the rollers 15 can be movable, viz., mounted on a movable dolly, translating on dedicated rails, so that the pitch, wheelbase, between two contiguous rollers 15 can be varied.

The experiments conducted by the Applicant have shown that the portion of a finished product of a rolling process, e.g., a rolled bar, which has non-uniform mechanical characteristics can be traced back to the joining area by means of welding two heated billets 2a, 2b. It was therefore determined that, during the welding step, the joining area is a thermally altered area shared between the two billets 2a, 2b, in the sense that the welding operation increases the temperature locally. This causes a different behaviour during the rolling procedure of the thermally altered area and results in different, often lower, mechanical strength values in the portion of the finished rolled bar corresponding to this portion of material than those obtained on the rest of the rolled bar, viz., away from the thermally altered area.

Therefore, the rolling plant 1 according to the present invention comprises a joint cooling system 40 arranged downstream of the welding machine 30 along said feed direction.

The joint cooling system 40 allows to remove heat from the thermally altered area, reducing the temperature difference with respect to the rest of the billet 2a, 2b. Consequently, the mechanical characteristics of the portion of the finished rolled bar corresponding to the thermally altered area are also much more similar to those of the rest of the finished bar.

With reference to the embodiment illustrated in FIG. 2, the joint cooling system 40 comprises a cooling device 50 arranged downstream of the welding machine 30 next to the welding machine 30. Thanks to this feature, it is possible to start lowering the temperature of the joining area as soon as the welding step is completed, and in particular, it is possible to cool down the areas of the billets 2a, 2b which are thermally altered following the welding step.

With particular reference to FIG. 3, the cooling device 50 defines a space therein which is configured to allow the passage of the billets 2a, 2b and comprises a plurality of dispenser nozzles 51, 52, 53, 54, 55, 56 connected to respective conduits 57, 58, 59 of refrigerant fluid, e.g., one or more of water, air, argon, in turn connected to a source and/or tank of refrigerant fluid.

According to a particularly advantageous feature, the dispenser nozzles 51, 52, 53, 54, 55, 56 are configured to be arranged facing, e.g., two by two, towards said inner space, viz., towards one or more of the outer surfaces of the billets 2a, 2b, so as to make the cooling as homogeneous as possible over the entire perimeter of the billets 2a, 2b.

According to a further possible feature illustrated in FIG. 3, the dispenser nozzles 51, 52, 53, 54, 55, 56 are arranged spaced from each other along said predetermined feed direction X so that, in use, they are facing upstream and downstream of the joining area 7 and thus cool the thermally altered areas A, A′ of the billets 2a, 2b, but not directly the area corresponding to the welding burr.

According to a further embodiment of the present invention illustrated in FIG. 4, the rolling plant 1 comprises a carriage, or dolly 32, movable along the predetermined longitudinal feed direction X. In particular, the dolly 32 is placed between the heated billet production assembly 10 and the rolling mill 20, and is movable according to two directions, from and to the reheating furnace or continuous casting 10, and from and to the rolling mill 20. For example, but not limitedly, the dolly 32 can comprise a plurality of wheels and a geared pinion driven by a gear motor, which by means of a gear rack allow the carriage 32 to be moved on a rail in either direction.

The welding machine 30 is arranged on the movable dolly 32.

Thanks to this configuration, in use, the movable dolly 32, and thus the welding machine 30, can be moved along the unloading direction towards the rolling mill 20, synchronising the speed of its travel with the travel speed of the billets 2a, 2b. Thereby, the welding machine 30 welds the tail 3 of a first billet 2a already output by the reheating furnace or continuous casting 10 with the head 5 of a second billet 2b in output from the reheating furnace or continuous casting 10, without the need to interrupt the movement of the two billets 2a, 2b. Once the welding step is complete, the movable dolly 32 is moved in the opposite direction, viz., towards the heated billet production assembly 10, to be able to begin a new welding step between the tail of the second billet 2b and the head of a third billet in output from the heated billet production assembly 10.

According to this embodiment, the cooling device 50 is arranged on the movable dolly 32 downstream of the welding machine 30.

According to a further embodiment of the present invention illustrated in FIG. 5, the joint cooling system 40 comprises a cooling device 60 arranged downstream of the welding machine 30. The cooling device 60 is movable along the predetermined longitudinal feed direction X from and to the welding machine 30 and from and to the first stand 22.

With particular reference to FIG. 6, the movable cooling device 60 comprises a plurality of dispenser nozzles 62 arranged distributed on a manifold 64. The manifold 64 is in turn connected to a refrigerant conduit 66, for example one or more of water, air, argon, which in turn is connected to a source and/or tank of refrigerant.

The manifold 64 is arranged vertically superimposed on the feed path of a billet 2 along said predetermined X-direction, and preferably has an inverted ‘U’ shape. Thanks to this shape, the dispenser nozzles 62 are arranged distributed on the manifold 64 so as to be arranged facing several surfaces of the billet 2a, and thus favour the cooling of the thermally altered area.

Of course, it will be possible to envisage, without exerting any inventive effort, different configurations of the dispenser nozzles 62 and/or geometries of the manifold 64 as long as the dispenser nozzles are capable of spraying refrigerant on the surface of the billets 2a and 2b at the thermally altered area and allowing its temperature to decrease at the end of the welding step.

The manifold 64 is engaged to a movement member 70 adapted to move the manifold 64 along the predetermined billet feed direction X. According to the illustrated embodiment, the manifold 64 is engaged to a connected dolly 68 sliding on an arm 69. The arm 69 is in turn connected to the movement member 70.

The movement member 70, in the embodiment illustrated, can comprise a geared pinion driven by a gear motor, which, by means of a gear rack, allows the arm 69 to be moved on a rail according to the two movement directions along a movement axis parallel to the predetermined longitudinal feed direction X.

Of course, it is also possible to envisage different embodiments of the movement member 70 without departing from the scope of the present invention. For example, according to a possible embodiment, not illustrated, the movement member is movably arranged along a movement axis coinciding with the predetermined longitudinal feed direction X.

The movement member 70 can synchronise the movement speed of the manifold 64 along the feed direction X with the travel speed of the billets 2a, 2b. Thanks to this feature, it is possible to prolong the cooling time of the thermally altered area, by means of water sprayed by the nozzles 62, without modifying, viz., slowing down, the travel speed of the billets 2a, 2b themselves.

According to the embodiment illustrated in FIG. 6, the dolly 68 allows the adjustment of the position of the manifold 64 both transversely along the arm 69 and vertically with respect to the billets 2a, 2b.

The dolly 68 is selectively movable along the arm 60 to allow the translation of the manifold 64 between a working position B and a maintenance, or override, position B′ of the joint cooling system 40.

The dolly 68 also allows to adjust in height the position of the manifold 64, and thus of the dispenser nozzles 62, to better centre them with respect to the faces of the billets 2a, 2b, viz., the thermally altered area, to be cooled.

According to a further embodiment of the present invention illustrated in FIG. 7, the joint cooling system 40 comprises one or more static cooling devices 80 arranged between two successive rolling stands 22, 22′, 22′, 22″ along the predetermined feed direction X of the billets 2a, 2b, viz., along the rolling direction.

With particular reference to FIG. 8, each static cooling device 80 comprises a support structure 82 fixed to the ground, to which a manifold 84 is engaged, on which a plurality of dispenser nozzles 86 are arranged. The manifold 84 is connected to a refrigerant conduit (not illustrated) which in turn is connected to a source and/or tank of refrigerant, e.g., one or more of water, air, argon. In the embodiment illustrated, the manifold 84 has a substantially circular shape and the dispenser nozzles 86 are evenly distributed along the inner circumference of the manifold 84.

This configuration is particularly advantageous in that the rolling stock, and therewith the portion of the rolling stock corresponding to the thermally altered area, is lengthened and reduced in section as a result of the deformation work performed by the rolling stands during the rolling process.

The thermally altered area passing through the static cooling devices 80 undergoes a further cooling, resulting in improved mechanical characteristics of the finished product.

Of course, the number and arrangement of the static cooling devices 80 between two stands 22, 22′, 22″, 22′″ of the rolling mill 20 may vary from what has been described and illustrated herein without departing from the scope of the present invention.

In this case, since the cooling device 80 is static, the switching on and off of the dispensing nozzles 86, in use, is synchronised with the position of the thermally altered area of the rolling stock during its travel along the rolling direction X with respect to the cooling device 80, so as to operate the localised cooling thereof in the transient of passage of the thermally altered area of the rolling stock under the manifold 84.

According to a further embodiment of the present invention illustrated in FIG. 9, the joint cooling system 40 comprises one or more static cooling devices 90, 100 arranged between the last rolling stands 24, 24′, 24″, viz., in that area of the rolling mill 20 in which the rolling stock assumes higher speed values with respect to previous zones of the rolling mill train 20 or of the whole plant 1.

With particular reference to FIG. 10, a first static cooling device 90 comprises a support structure 92 fixed to the ground, to which a pressurised water cooling system is engaged, e.g., a cooling pipe 94 within which, in use, a rolling stock 4 passes, consisting of a plurality of billets 2a, 2b previously welded together.

With particular reference to FIG. 11, a second static cooling device 100 comprises a pair of support structures 102 fixed to the ground, to which a second pressurised water cooling system is engaged, for example, a cooling pipe 104 within which, in use, a rolling stock 4 passes, comprising a plurality of billets 2a, 2b previously welded together.

Of course, it is possible to envisage different types of pressurised water cooling systems, e.g., high-pressure pipes in turbulent regime in equi-current and/or counter-current, as well as different types of static cooling devices, e.g., those described above, without departing from the scope of the present invention.

According to a particularly advantageous feature, the cooling pipes 94, 104 are sized to have a length value less than the extension value of the thermally altered area and comprise flow adjustment valves (not illustrated) for the refrigerant. It is thereby possible to punctually intervene with the cooling action on the thermally altered section and without affecting the temperature of the remaining part of the rolling stock 4.

Given the travel speed of the rolling stock 4 in this section of the rolling mill 20, the time for switching on the cooling pipes 94, 104 is very short, but a predetermined combination of pressure and dispensing flow rate of the refrigerant have an effective effect in lowering the temperature of the thermally altered area.

Numerous experiments conducted by the Applicant have shown that a multiple-billet hot rolling plant with a joint cooling system in which the joint cooling system 40 comprises two or more of the above-described embodiments of the joint cooling system in combination achieves even better final results on the rolled product.

For example, according to a first of the further embodiments of the present invention, the joint cooling system 40 comprises a first cooling device 50 arranged downstream of and at the welding machine 30, both arranged on a dolly 32, movable along the predetermined longitudinal feed direction X according to two directions, from and to the heated billet production assembly 10, and from and to the rolling mill 20, and a plurality of static cooling devices 80 arranged between two successive rolling stands 22, 22′, 22′, 22′″ along the predetermined feed direction X of the billets 2a, 2b, viz., along the rolling direction.

For example, according to a second of the further embodiments of the present invention, the joint cooling system 40 comprises a first cooling device 50 arranged downstream of next to the welding machine 30, both arranged on a dolly 32, movable along the predetermined longitudinal feed direction X according to two directions, from and to the heated billet production assembly 10, and from and to the rolling mill 20, and a movable cooling device 60 along the predetermined longitudinal feed direction X from and to the welding machine 30 and from and to the first stand 22, and one or more static cooling devices 90, 100 arranged between the last rolling stands 24, 24′, 24′.

Of course, any possible combination of the plurality of embodiments of the joint cooling system 40 arranged in the multiple-billet hot rolling plant described so far is comprised in the scope of protection of the present application.

According to a preferred embodiment of the present invention, the joint cooling system 40 comprises:
a first cooling device 50 arranged downstream next to the welding machine 30,
a movable cooling device 60 arranged between the welding machine 20 and the first stand 22 of the rolling mill 20 along the predetermined longitudinal feed direction X,
a plurality of static cooling devices 80 arranged between two successive rolling stands 22, 22′, 22′ 22′″ along the predetermined feed direction X of the billets 2a, 2b, viz., along the rolling direction, and
one or more static cooling devices 90, 100 arranged between the last rolling stands 24, 24′, 24″.

The overall result of the combination of a plurality of cooling devices arranged along the rolling plant is the achievement of a uniform temperature, within a narrow tolerance range, between the thermally altered area of the rolling stock, and the remaining areas of the rolling stock, and, consequently, an almost uniform distribution of the mechanical characteristics of the bar along the finished product.

The experiments conducted by the Applicant have also allowed to develop a procedure for controlling the joint cooling system 40.

With particular reference to all the mobile 60 and static 80, 90 and 100 cooling devices, as well as for the cooling device 50 arranged on the dolly 32, for their correct operation it is necessary to determine the moment in which to activate them, viz., to determine the moment in which the thermally altered area passes through said cooling devices.

For this reason, the multiple-billet hot rolling plant with a joint cooling system according to the present invention also comprises a management and control system of the cooling devices 50, 60, 80, 90, 100. Said management and control system comprises one or more electronic process controllers capable of communicating with the cooling devices by means of I/O devices. The electronic process controllers and cooling devices can be connected to each other by means of wired or wireless data transmission systems. The electronic process controllers can be installed on one or more workstations near the rolling plant, on remote workstations or on portable electronic devices.

The switching on and off is automatically managed by the management and control system on the basis of a tracking system of the position of the thermally altered area along the entire rolling mill, so that the cooling action of the cooling devices 50, 60, 80, 90, 100 is only activated when the thermally altered area of the rolling stock transits at the cooling devices 50, 60, 80, 90, 100.

Furthermore, it was determined that the duration of the cooling step, e.g., the time interval for switching on the dispensing nozzles 51, 52, 53, 54, 55, 56, 62, and the cooling intensity, flow rate and/or temperature, of the refrigerant, optimises and makes the reference parameters and thus the resulting mechanical characteristics uniform.

1. A multiple-billet hot rolling plant with a joint cooling system comprising:
a heated billet production assembly (10) configured to unload a plurality of heated billets (2a, 2b) along a predetermined longitudinal feed direction (X),
a rolling mill (20) comprising a plurality of stands (22, 22′, 22″, 22′″) and arranged downstream of the heated billet production assembly (10) along said feed direction (X),
a welding machine (30) arranged between the heated billet production assembly (10) and a first stand (22) of the rolling mill (20) along said feed direction (X),
the system (1) comprises a joint cooling system (40) arranged downstream of the welding machine (30) along said feed direction (X),
characterised in that the joint cooling system (40) comprises a cooling device (60) arranged downstream of the welding machine (30), said cooling device (60) being movable along the predetermined longitudinal feed direction (X) from and to the welding machine (30) and from and to the first stand (22).

2. Plant according to claim 1, characterised in that the joint cooling system (40) comprises a cooling device (50) arranged next to the welding machine (30).

3. Plant according to claim 2, characterised in that the cooling device (50) comprises a plurality of dispenser nozzles (52, 53, 54, 55, 56) connected to respective conduits (57, 58, 59) of refrigerant, the dispensing nozzles (52, 53, 54, 55, 56) being configured to be arranged facing one or more of the outer surfaces of the billets (2a, 2b).

4. Plant according to claim 2, characterised in that the welding machine (30) and the cooling device (50) are arranged on a dolly (32) which is movable along the predetermined longitudinal feed direction (X) in two directions, from and to the reheating furnace (10), and from and to the rolling mill (20).

5. Plant according to claim 4, characterised in that the cooling device (60) comprises a manifold (64) connected to a conduit of refrigerant (66), and a plurality of dispensing nozzles (62) arranged distributed on the manifold (64).

6. Plant according to claim 5, characterised in that the manifold (64) is engaged to a movement member (70) adapted to move the manifold (64) along the predetermined billet feed direction (X).

7. Plant according to claim 1, characterised in that the joint cooling system (40) comprises one or more static cooling devices (80) arranged between two successive rolling stands (22, 22′, 22′, 22′″) along the predetermined feed direction (X) of the billets (2a, 2b).

8. Plant according to claim 7, characterised in that the one or more static cooling devices (80) comprise a support structure (82) to which a manifold (84) is engaged, on which a plurality of dispensing nozzles (86) are arranged, the manifold (84) being connected to a refrigerant conduit.

9. Plant according to claim 1, characterised in that the joint cooling system (40) comprises one or more static cooling devices (90, 100) arranged between the last rolling stands (24, 24′, 24″) of the rolling mill (20).

10. Plant according to claim 9, characterised in that the static cooling device (90, 100) comprises a support structure (92, 102) fixed to the ground, to which a pressurised water cooling system (94, 104) is engaged.

11. Plant according to claim 1, characterised in that the joint cooling system (40) comprises:
a first cooling device (50) arranged downstream next to the welding machine (30),
a movable cooling device (60) arranged between the welding machine (20) and the first stand (22) of the rolling mill (20) along the predetermined longitudinal feed direction (X),
a plurality of static cooling devices (80) arranged between two successive rolling stands (22, 22′, 22′, 22′″) along the predetermined feed direction (X) of the billets (2a, 2b), and
one or more static cooling devices (90, 100) arranged between the last rolling stands (24, 24′, 24″) of the rolling mill.
